(19) United States
(12) Patent Application Publication
(10) Pub. No.: US 2003/0161966 A1
(43) Pub. Date: Aug. 28, 2003

(54) System and method of coating a continuous length of material

(76) Inventors: James Cannon Bible, Kings Mountain, NC (US); Robert Antoine Wright, Louisville, KY (US)

Correspondence Address: JAMES C. EAVES JR., GREENEBAUM DOLL & MCDONALD PLLC, 3300 NATIONAL CITY TOWER, 101 SOUTH FIFTH STREET, LOUISVILLE, KY, 40202, US

(21) Appl. No.: 10/082,375

(22) Filed: Feb. 25, 2002

(51) Int. Cl. C08F 2/46

(52) U.S. Cl. 427/496; 427/501; 427/508; 72/47; 118/620

(57) ABSTRACT

A system and method for coating a length of material 1 with and electron-beam curable coating or an ultraviolet curable coating comprises placing a portion of the material to be coated under tension or compression and driving or pulling the material 1 through a coating system 100 whereby a liquid coating is applied. The material 1 is then exposed to electron beam radiation and/or ultraviolet radiation to cure the coating applied thereto.

### BACKGROUND

Many prior art processes for coating various materials that are capable of being continuously produced apply solvent-based coatings in a paint booth or similar chamber prior to feeding the coated material through a drying oven to cure the coating. In the curing process the material being coated is heated to a temperature sufficient to cure the coating by evaporating the solvent base therefrom, without damaging the remaining coating. Typically, coatings for coloring or otherwise marking a material are applied and cured in this fashion.

The application of color coatings to many materials is often accomplished “in-line” to enhance production economies. The material, for example sheet metal, metallic tube, non-metallic hose, or cabling is manufactured in a continuous piece that is cut into discrete predetermined lengths subsequent to a coating and curing process. The continuous material is typically washed and routed through a coating chamber, or a series thereof, wherein the coating is applied by flooding the material with a liquid coating or via a plurality of roller applicators. Known coating systems often employ a variety of air handling and vacuum systems for removing and filtering the various volatile organic compounds produced from evaporation of the solvent base from the coating chamber before the emissions may be released to atmosphere.

Electron beam curable coatings have been developed to replace the aforementioned heat curable coatings. Electron beam curable coatings are water-based liquid coatings that undergo polymerization and/or cross-linking when exposed to an electron beam, thereby altering the physical characteristics of the liquid coating to produce a different molecular structure from the original coating. Water-based liquid coatings may be applied to a variety of materials and cured by exposure to a directed stream of electron radiation. This electron beam (EB) curing process can be accomplished in a fraction of the time necessary for conventional oven curing. Many thermoplastic resins are also presently employed in a similar fashion.

The aforementioned methods for coating materials suffer from many disadvantages. In solvent-based coating applications the ovens used for curing must be quite long in order to completely cure and dry the applied coating prior to the material exiting the oven. For example, in sheet metal coating and curing applications, drying and curing ovens are typically in excess of one hundred feet in length for a material feed rate of 200 to 400 feet per minute. Ovens of this size consume tremendous amounts of natural gas to heat the coated material and require a great deal of costly building space.

Furthermore, conventional solvent-based coatings are quite expensive to handle due to the environmental necessity of removing the various volatile organic compounds present in the solvent emissions. Additionally, solvent based coatings eventually cure at ambient temperatures. This ambient curing makes it difficult to simply stop the coating process to maintain equipment, or to change coatings, because the coating begins to cure on any coating equipment exposed thereto.

While EB and thermoplastic coatings and curing systems reduce the cost of curing many coatings and the concomitant emissions of solvent-based coatings, the coating application process still requires an even application of coating to all surfaces of the material to be coated. Prior art systems typically route the material through a series of rollers or a fog of liquid particles entrained in air to apply the coatings prior to exposing the material to an electron beam or ultraviolet light. After coating, the continuous material to be cured must be routed into the curing process via a plurality of rollers and guides thereby increasing the incidence of blemishes and inconsistencies on the cured finish surface.

### SUMMARY OF THE INVENTION

The instant invention obviates the aforementioned problems by providing a system and method for coating a continuous length of material with either an electron beam curable coating or an ultraviolet light curable coating thence curing the coatings through exposure to electron beam radiation or ultraviolet light. The instant invention is suited for use in both metallic and non-metallic product applications where a large throughput of coated material is desired.

A portion of the continuous material being coated is placed under tension during the coating application and curing steps to ensure an even coating process. Since the material does not have to be touched during the coating and curing, the resultant cured coating surface is even and free of imperfections caused by the rollers and guides commonly used to route material through the process.

The instant invention is particularly suited for use with materials that can be coated with electron beam-curable coatings or ultraviolet light curable coatings. These water-based curable coatings are often applied by creating a uniform fog of liquid coating particles through which the material under tension is passed, thence exposed to directed electron beam or ultraviolet light radiation to provide even curing on all material surfaces.

A plurality of electron beam accelerators may be positioned at a plurality of discrete locations proximate the coated material to ensure complete and rapid curing of all material surfaces. Each accelerator generates electron beam radiation having an intensity that may be adjusted for curing specific coating and material. Additionally, ultraviolet light sources may be positioned at a plurality of locations proximate the coated material for use with UV curable coatings. Once coated and cured, the material is then cut to length, coiled, or prepared for subsequent processing.

Therefore, it is an object of the present invention to evenly coat a plurality of materials capable of accepting electron beam-curable coatings.

It is a further object of the instant invention to evenly coat a plurality of materials capable of accepting ultra-violet curable coatings.

It is a further object of the instant invention to provide a process whereby the material to be coated is not contacted by any object during the coating and curing steps thereof.

It is a further object of the instant invention to apply a tensile force to a portion of the material being coated and cured to prevent contact therewith.

It is a further object of the instant invention to expose a coated material to electron beam radiation produced by at least one electron beam accelerator to cure the coating thereon.

It is a further object of the instant invention to expose a coated material to ultraviolet light produced by at least one ultraviolet light source to cure the coating thereon.

It is a yet further object of the instant invention to provide a process for coating a continuous length of material that requires minimizes equipment space and operating costs.

Other objects and advantages of the instant invention will be apparent after reading the detailed description of the preferred embodiments, taken in conjunction with the drawing figures.

### DESCRIPTION OF THE DRAWINGS

FIG. 1 is schematic diagram of an embodiment of the present invention employed in a tube mill production application;

FIG. 2 is an elevation view of a forming mill in accordance with the present invention;

FIG. 3 is a cross-sectional view of subsequent passes of material being formed into a tube in accordance with the instant invention;

FIG. 4 is an isometric diagram of a welding system in accordance with the instant invention;

FIG. 5 is an isometric diagram of a welding system in accordance with the instant invention;

FIG. 6 is an isometric diagram of a welding system in accordance with the instant invention;

FIG. 7 is an elevation view of a sizing mill in accordance with the instant invention;

FIG. 8 is a schematic diagram of a wash system in accordance with the instant invention;

FIG. 9 is a schematic diagram of a coating system in accordance with the instant invention;

FIG. 10 is a schematic diagram of a vacuum coater in accordance with the instant invention;

FIG. 11 is a view of the instant invention along the line 11-11 of FIG. 9;

FIG. 12 is a schematic diagram of the curing system in accordance with the instant invention;

FIG. 13 is a view of an ultraviolet curing system in accordance with the instant invention;

FIG. 14 is a view of the instant invention taken along the line 14-14 of FIG. 13;

FIG. 15 is a schematic diagram of an alternative embodiment of the instant invention.

### DETAILED DESCRIPTION OF THE PREFERRED EMBODIMENT(S)

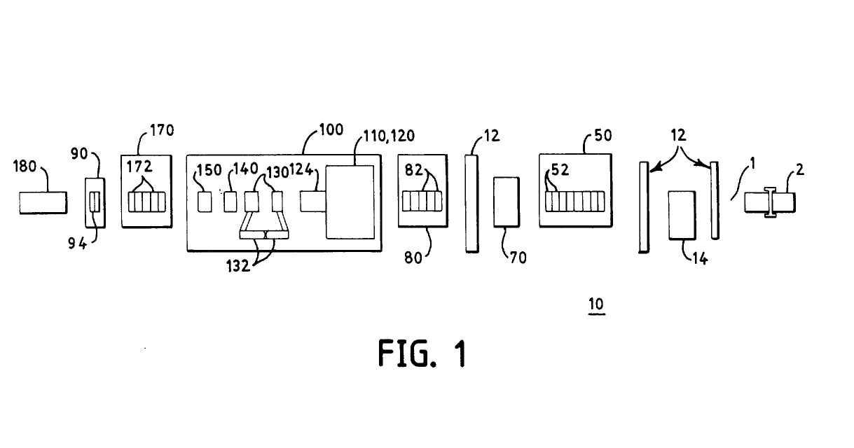

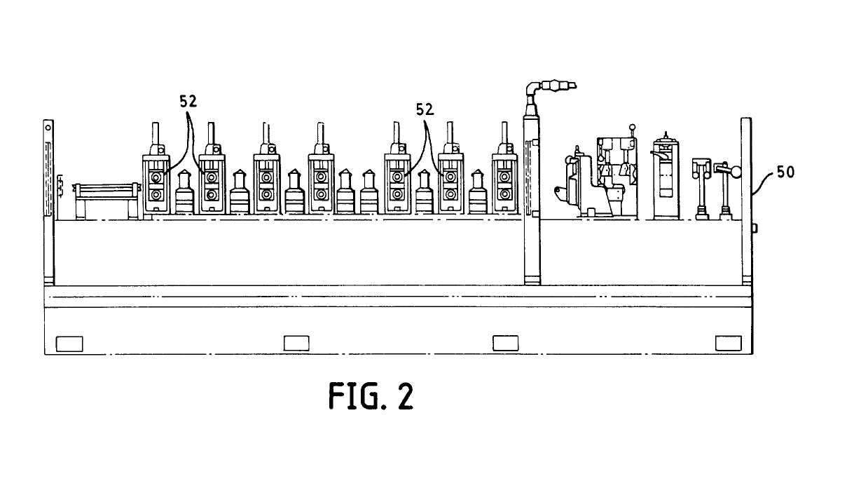

FIGS. 1 and 2 illustrate a material coating and curing application employing the system and method of the instant invention practiced in the environment of a conventional mill for producing metallic tube. While the example employed throughout is that of a tube production mill, one of ordinary skill in the art will recognize that the instant invention is susceptible of modification for use in a wide variety of material coating applications. In accordance with a constructed embodiment of the present invention, a system 10 and method for coating and curing a continuous length of material 1 comprises the steps of applying a tensile force to a portion of the continuous length of material 1, applying an electron beam or ultraviolet light curable coating thereto, and exposing said coating to at least one electron beam radiation source or ultraviolet light source without contacting the portion of material 1 under tension until the coating is completely cured. While the examples in the detailed description refer to a sheet aluminum strip, the present invention may also be practiced with other types of materials, for example steel sheet or steel strip, non-metallic sheet or strip, braided cable or the like.

In the metallic tube process shown in FIGS. 1 and 2, a coil reel of sheet steel 2 capable of rotation about a central axis is provided as a raw material. An end of the sheet steel strip 2 is fed into the system 10 through a plurality of conventional supports or guides 12 into a tube forming mill 50, for example a QVT-200 Tube Mill as produced by the Yoder Manufacturing Company of Cleveland, Ohio. The coil reel provides a support means for the sheet aluminum as it enters the tube mill 50. Ancillary systems such as a strip end detector, an end welder 14 and a strip storage accumulator permit continuous mill production by accumulating a portion of sheet aluminum to be fed into the mill while a new coil is welded onto the end of the existing coil 2, as is well known to one of ordinary skill in the art.

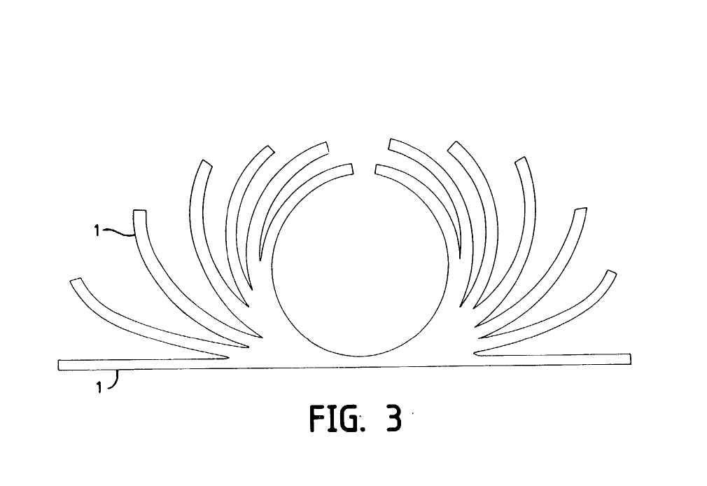

Once the sheet aluminum strip 2 enters the forming mill 50 it is guided through a series of rolls 52 in a plurality of driven (motor-driven) passes prior to welding. The rolls 52 are typically matching male and female rolls having variable decreasing radii which force the strip 2 into a partial or open cylindrical shape as it is driven through the forming mill 50. The number of driven passes required for a given metallic tube production application is dependent upon the thickness to diameter ratio of the sheet aluminum being formed. Either single radius forming rolls 52 or edge forming rolls 54 are employed in each of the plurality of driven passes, as the nature of the aluminum strip 2 requires. FIG. 3 depicts a cross-sectional view of the material 1 as it completes sequential passes through the series of forming rolls 52.

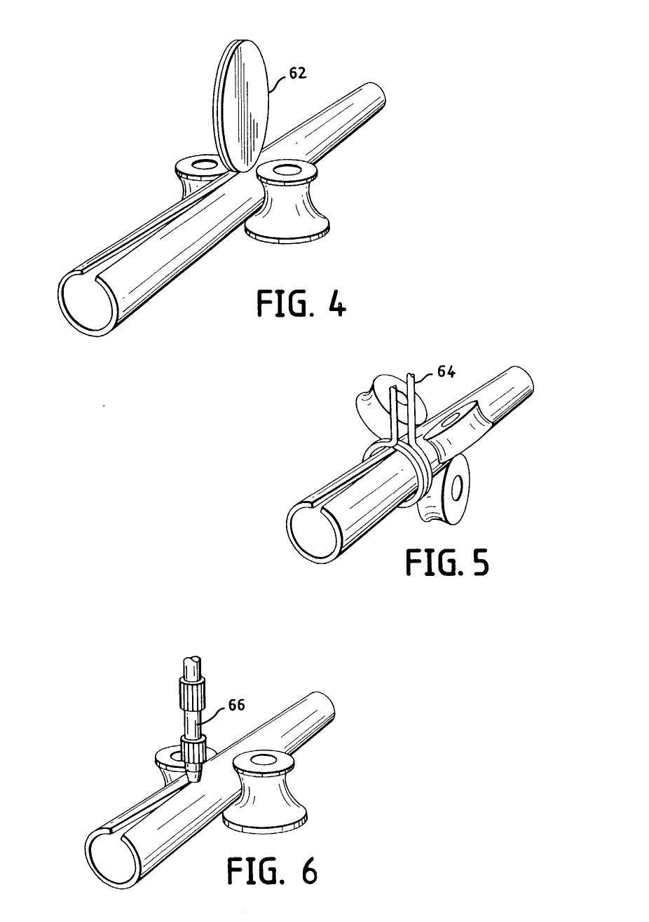

Once formed, the tube enters a welding stage whereby the opposed rolled edges of the strip 2 are welded together using one of a plurality of known in the art welders 60 as shown if FIGS. 4, 5, and 6, thereby forming a cylindrical tube. For example, AC or DC electric resistance welding, square wave electric resistance welding, radio frequency induction welding, high or low frequency welding, or fusion welding techniques (MIG, TIG, Plasma) may be employed to weld the tube edges. FIGS. 4 through 6 depict a rotating electrode type welder 62, a high frequency welder 64, and a fusion welder 66 respectively, each of which may be used in the system and method of the instant invention depending upon the type of material 1 to be welded.

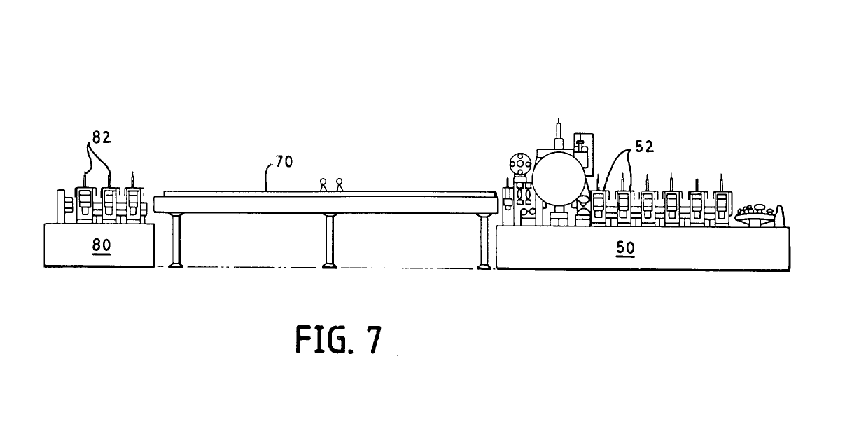

As best seen in FIGS. 1 and 7 the welded tube next passes into a cooling section 70 of the system 10 to remove a portion of the latent heat therein. The cooling step permits the welded tube to attain an even temperature around its circumference prior to sizing and straightening. The cooled tube next enters a sizing mill 80 where it passes through a plurality of progressively more restrictive horizontal and vertical rolls 82 to attain it's desired manufactured size. The vertical and horizontal rolls 82 may be a combination of driven (motorized) rolls and idle rolls. In passing through each subsequent roll, the tube size is reduced slightly, but sufficiently to exceed the elastic limit of the material, thereby compensating for material spring-back. The sizing mill 80 further provides a point against which the tube can be pulled to create a tensile force therein, as will be described further below.

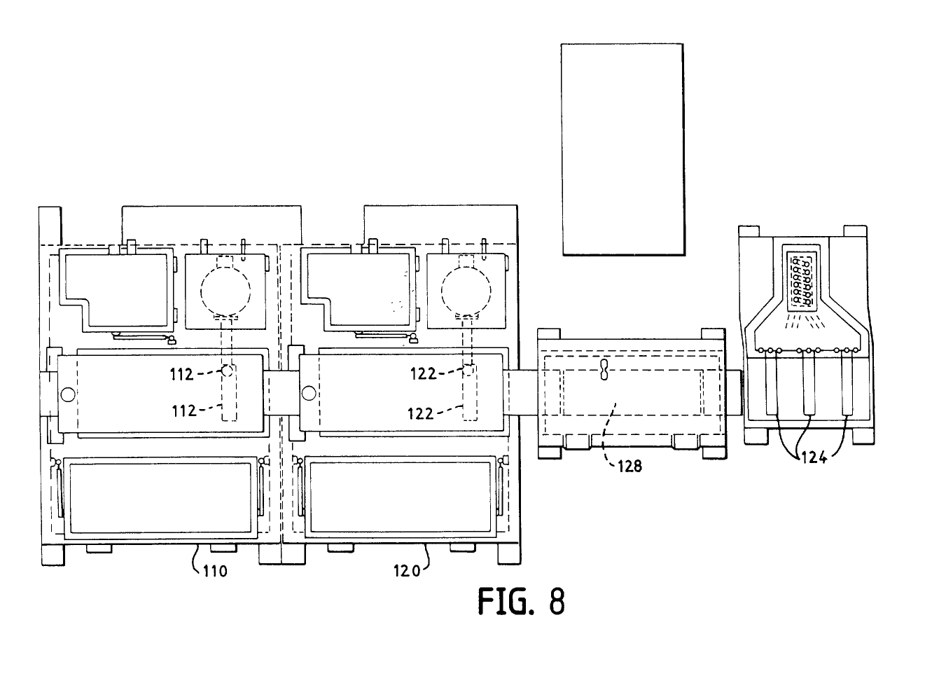

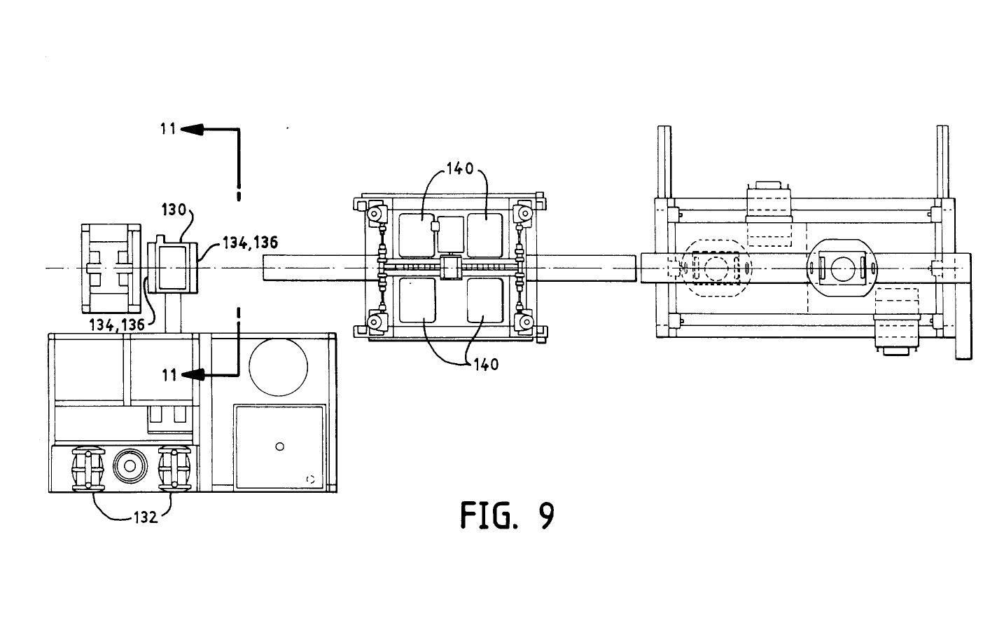

The newly formed tube enters a coating system 100 having the following stages: a wash stage, a rinse stage, an optional sealer or primer application stage, a dryer stage, a coating application stage, and a curing stage. The coating system 100 employed in the the present invention is capable of application of transparent, semi-transparent and opaque coatings. The material 1 being coated first enters a wash stage whereupon the material 1 is washed, rinsed, (optionally sealed), and dryed in preparation for coating. Referring to FIG. 8, the material 1 is routed through an in-line spray wash system 110 that utilizes high pressure spray wash supplied through a plurality of spray nozzles 112. In the case of metallic material, the wash is typically an alkaline solution, as is known to one of ordinary skill in the art.

The material 1 next enters a high pressure “halo” water spray rinse section 120, wherein a halo of water spray is supplied through a second set of nozzles to remove all the wash solution and any remaining contaminants therefrom. In an alternative embodiment of the instant invention, the material 1 thence passes through a flood chamber 128 containing a rust preventative solution or a primer/sealer. Finally, the material 1 passes through a plurality of air knives 124 that surround the material with heated air to remove any remaining excess solution from the material 1 prior to coating. The wash, rinse, seal and dry stages may be accomplished using known in the art wash systems, for example a Hydrajet™ wash system as produced by the ATR corporation of Houston, Tex.

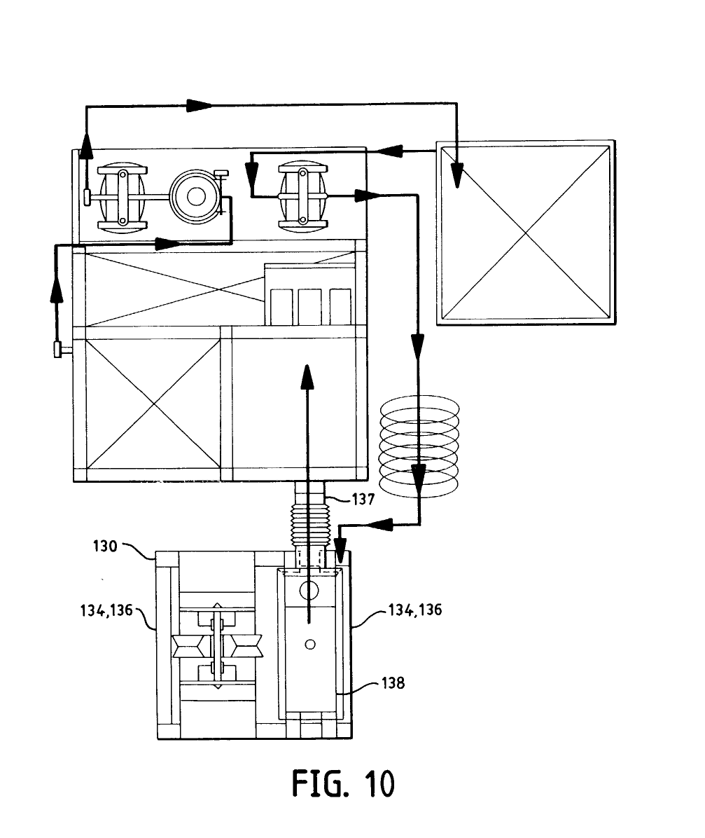

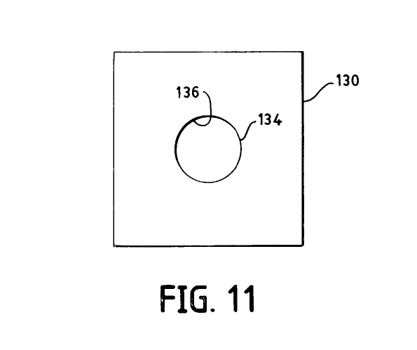

Referring now to FIGS. 9, 10, and 11, the in-line application of a curable liquid coating to the continuous tube is preferably accomplished in a vacuum coating chamber 130 wherein the thickness of the coating application may be controlled by regulating a flow of a gas through the coating chamber 130 via a plurality of vacuum pumps 132. The coating chamber 130 includes entry and exit templates 134, each having an orifice 136 therein. The orifices 136 are shaped to represent the outline of a cross-section of the material 1 being coated with a slight gap around the cross-sectional profile.

The vacuum pumps 132 pull gas into the coating chamber 130 through the gaps between the orifices 136 and the material 1, wherein a liquid coating is supplied to the coating chamber 130 through a dedicated supply line 137 and an associated coating head 138. The liquid entering the chamber is then entrained in the gas flowing therethrough while the tube is traveling through the chamber 130, thereby providing an even coating application to the exterior surfaces of the tube. The gas used in the coating chamber 130 may be any of the inert gasses or ambient air, as the particular coating being used requires.

The coating system 100 employed in the instant invention is capable of applying either electron-beam curable coatings (hereinafter “EB”) and ultraviolet curable coatings (hereinafter “UV”) to the metallic tube. EB coatings include printing inks, varnishes, silicone release coatings, primers, pressure sensitive adhesives, and various barrier coatings. When exposed to a directed electron beam the aforementioned coatings undergo polymerization whereby molecular groupings in the liquid (uncured) coating combine to form a large molecular group known as a polymer. Furthermore, cross-linking of the many polymer chains into an interconnected network of molecular structure of the coating in the final cured coating also occurs as a result of electron beam exposure, thereby producing an enhanced coating that is resistant to elevated temperatures.

The tube next enters the curing stage of the coating system 100 wherein a plurality of electron beam accelerators 140 to generate a stream of electrons to curing the applied liquid electron beam curable coating, as shown in FIGS. 1, 9, and 12. Electron accelerators 140, for example those disclosed in U.S. Pat. No. 5,962,995 to Avnery, incorporated herein by reference, are particularly suited for use in the system and method of the instant invention due to their compact construction. At least one accelerator 140 is positioned proximate the tube or material 1 such that the electron radiation produced thereby is directed to evenly expose all coated surfaces to radiation.

In an alternative embodiment of the invention, a plurality of electron beam accelerators 140 may be used to achieve an evenly cured coating. The positions of said plurality of accelerators 140 relative to the centerline of the moving tube or material depend upon the shape of the tube, or other material to be cured. For example, when curing tube having an essentially circular cross section a pair of electron beam accelerators 140 may be positioned 180 degrees apart from each other around the circumference of the tube to evenly cure the coating applied thereto. In the case of square tube production, four accelerators 140 may be positioned 90 degrees apart around the tube to evenly cure all four sides thereof As is well known to one of ordinary skill in the art, the exact positioning of the electron beam accelerators 140 relative to the material being cured in the process of the instant invention depends upon the orientation of the coated surfaces of the material 1 relative to the radiation produced by the accelerators 140, and the intensity of electron beam exposure required for thorough curing of the specific coating applied.

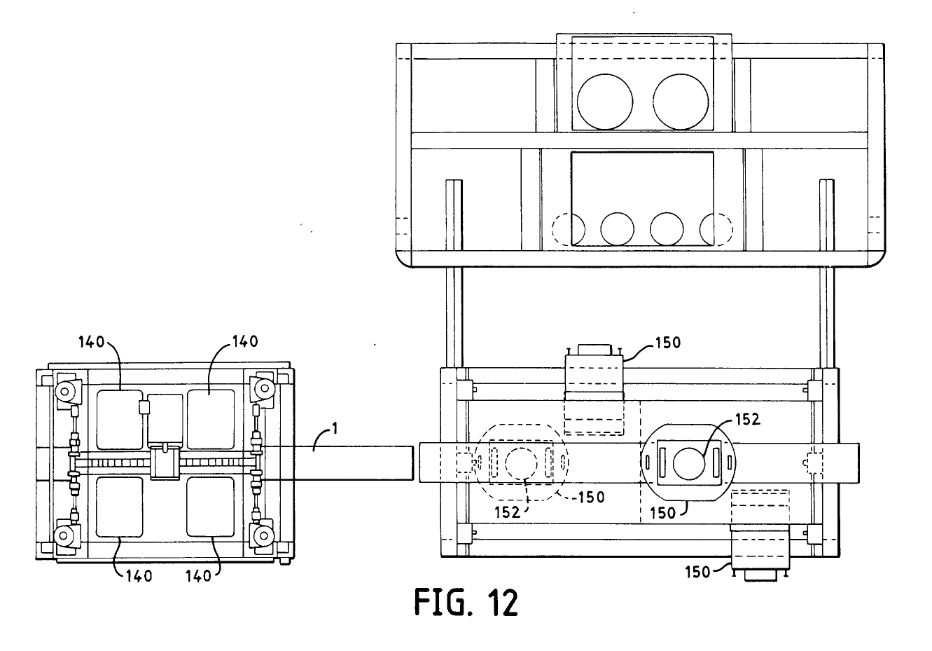

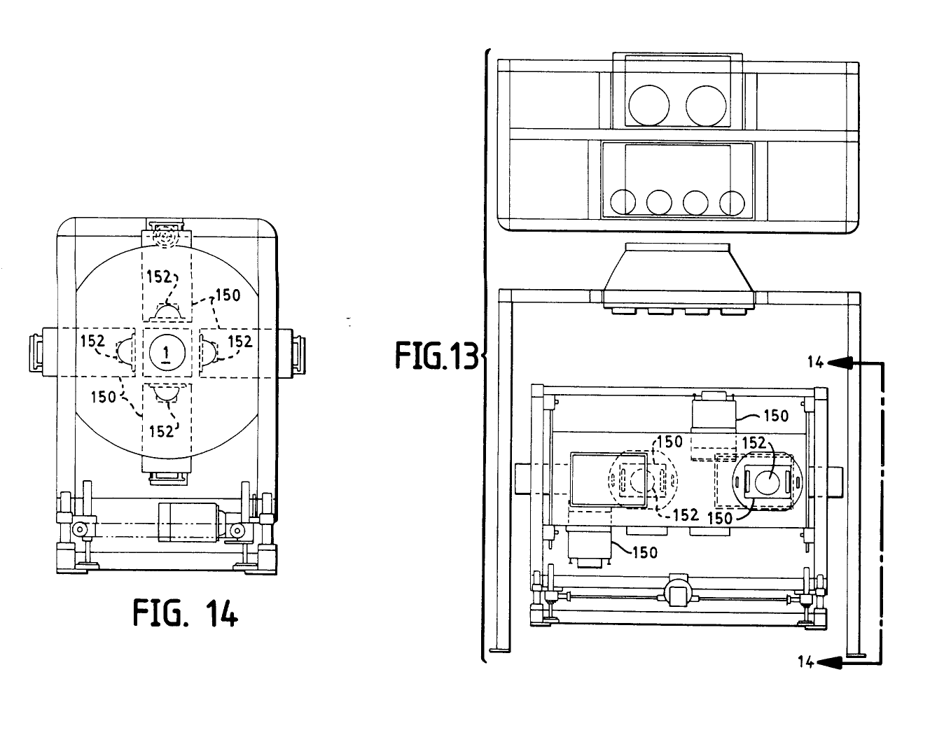

Referring now to FIGS. 12, 13 and 14, in addition to electron beam accelerators 140, a plurality of ultraviolet light sources 150 may be arranged to provide a means for curing coatings sensitive to UV light exposure. Typically, commercially available ultraviolet light systems used for industrial coating cure applications generate intense radiation in the 200-400 nanometer region to instantaneously cure the UV sensitive inks and coatings. The ultraviolet light source typically comprises a lamp 152 and a power source (not shown) for supplying electrical excitation to the lamp 152. An exemplary UV curing system is available from Fusion UV Systems Inc. of Gaithersburg, Md. FIGS. 13 and 14 depict an exemplary arrangement of UV light sources 150 disposed at 90 degree increments relative to each other around the material 1 being cured.

Additionally, the UV light sources can be utilized to further cure the surface of an electron-beam curable coating. The additional UV curing step utilized in combination of the electron beam curing operates to surface cure the coating on the material to provide a matte finish, as opposed to gloss finishes often produced when using electron beam curing alone. Accordingly, when the combination of UV and electron beam curing is employed, the UV light sources 150 should be positioned downstream of the electron beam accelerators 140 as shown in FIG. 1.

After exiting the coating process (system) the coated and cured material 1 (tube) is routed into a pull-out mill 170, for example as produced by the Yoder Manufacturing Company of Cleveland, Ohio, prior to exiting the process and being cut into predetermined lengths. The pull out mill comprises a set of motor driven rolls 172 that stabilizes and aligns the coated tube prior to cutting in addition to “pulling” the tube through the coating and curing stages. The driven rolls 172 of the pull out mill 170 provide a tensile force on the portion of tube between the sizing mill 80 and the pull out mill 170. This feature of the present invention allows the portion of the tube being coated and cured to pass through the coating and curing process without contacting rollers, applicators, guides or the like, and without significant sag or curvature, thereby providing for an extremely even and consistent finished coating application.

The sized tube is finally routed through at least one turkshead type straightener 90 to reduce any remaining curvature of the tube to acceptable manufacturing tolerances prior to exiting the process and being cut into lengths. The turkshead straightener 90 utilizes a faceplate-type fixture 92 and a plurality of rolls 94 that operate to straighten the tube, similar to the operation of the forming and sizing mill sections. The finished coated tube may then be cut into predetermined lengths using a conventional cut-off saw 180 as necessary.

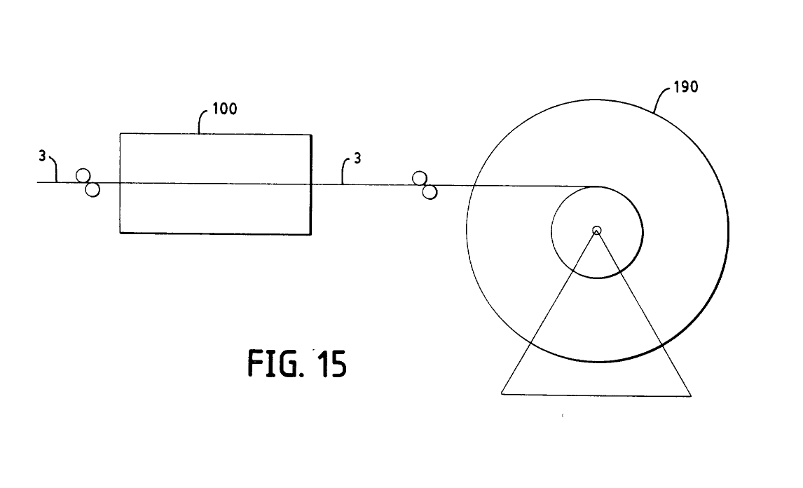

Referring to drawing FIG. 15, in an alternative embodiment of the instant invention, the method of coating a continuous length of material may be practiced on any material that is capable of being subjected to a tensile force and accepts the aforementioned electron beam or ultraviolet curable coatings. For example, during the production of metallic cable the wound cable 3 exiting the production process can be routed through the coating system 100 of the instant invention as described herein above, thence wound onto on a motorized take-up reel 190. The motorized reel 190 provides a constant tensile force on the metallic cable 3 as it travels through the coating system 100 during the coating and curing stage. Alternatively, once produced and spooled, uncoated cable spools may be individually coated and cured by simply routing the cable through the coating system 100 of the instant invention, under tension, from a supply reel to a take-up reel.

Furthermore, any material 1 that is capable of being subjected to a compressive force without exhibiting curvature or sag in the length of material that is being coated and cured may also be coated using the instant invention. For example, prefabricated tube that has been cut into lengths may be coated by feeding each length into a sizing mill 80, whereby the tube is driven through the coating system 100 of the instant invention by the plurality of motorized rolls 82. A pull out mill 170 may be provided at the exit of the coating system 100 to guide the tube through the coating system 100. Since the prefabricated tube is cool, it exhibits little sag or curvature while being driven under compression through the coating system 100.

The foregoing detailed description of the preferred embodiments is considered as illustrative only of the principles of the invention. Since the instant invention is susceptible of numerous changes and modifications by those of ordinary skill in the art, the invention is not limited to the exact construction and operation shown and described, and accordingly, all such suitable changes or modifications in structure or operation which may be resorted to are intended to fall within the scope of the claimed invention.

We claim:

1. A process for coating a continuous length of material comprising the steps of:
applying tension to a portion of said continuous length of material;
applying an electron-beam curable coating to the portion of said material under tension; and
exposing the coated portion of said material to an electron beam to cure the coating applied thereon.

2. A process for coating a continuous length of material comprising the steps of:
applying tension to a portion of said continuous length of material;
advancing the portion of said continuous length of material under tension through a coating system;
applying an electron beam curable coating to the portion of said material under tension; and
exposing the coated portion of said material to an electron beam to cure the coating applied thereon.

3. The process as claimed in claim 1 wherein said material is steel sheet.

4. The process as claimed in claim 1 wherein said material is steel tube.

5. The process as claimed in claim 1 wherein said material is steel cable.

6. The process as claimed in claim 1 wherein said material is non-metallic tube.

7. The process as claimed in claim 1 wherein said material is non-metallic cable.

8. The process as claimed in claim 1 wherein the step of applying a coating to said material is further comprised of the following steps;
washing the portion of said material under tension;
rinsing the portion of said material under tension;
drying the portion of said material under tension; and
applying an electron beam curable coating to the portion of said material under tension.

9. The process as claimed in claim 8 wherein the step of applying a coating to said material further comprises applying a sealant to the portion of said material under tension.

10. A method for producing coated metal tube comprising:
supplying a continuous length of sheet metal;
forming said continuous length of sheet metal into a continuous length of tube;
sizing said continuous length of tube to a predetermined diameter;
coating said continuous length of tube with an electron beam curable coating;
curing said continuous length of tube by exposing said length of tube to a plurality of electron beam emitters arranged in a predetermined pattern;
routing said continuous length of tube through a pull-out mill whereby a tensile force is maintained on said continuous length of tube; and,
cutting said continuous length of tube into a plurality of discrete lengths.

11. The method of producing coated metal tube of claim 10 wherein said coating step comprises:
washing said continuous length of tube;
rinsing said continuous length of tube;
drying said continuous length of tube; and
applying an electron beam curable coating to said continuous length of tube.

12. The method of producing coated metal tube of claim 11 wherein said coating step further comprises applying a sealant to said continuous length of tube.

13. A method for producing coated metal tube comprising:
supplying a continuous length of sheet metal;
forming said continuous length of sheet metal into a continuous length of tube;
sizing said continuous length of tube to a predetermined diameter;
coating said continuous length of tube with an ultraviolet light curable coating;
curing said continuous length of tube by exposing said length of tube to a plurality of ultraviolet light emitting lamps arranged in a predetermined pattern and;
routing said continuous length of tube through a pull-out mill whereby a tensile force is maintained on said continuous length of tube.

14. The method of producing coated metal tube of claim 13 wherein said coating step comprises:
washing said continuous length of tube;
rinsing said continuous length of tube;
drying said continuous length of tube; and
applying an ultraviolet light curable coating to said continuous length of tube.

15. The method of producing coated metal tube of claim 14 wherein said coating step further comprises applying a sealant to said continuous length of tube.

16. A method for producing coated metal tube comprising:
supplying a continuous length of sheet metal;
forming said continuous length of sheet metal into a continuous length of tube;
sizing said continuous length of tube to a predetermined size;
coating said continuous length of tube with a coating capable of being cured by either ultraviolet light or electron beam emission;
curing said continuous length of tube by exposing said length of tube to electron beam radiation and ultraviolet light; and
routing said continuous length of tube through a pull-out mill whereby a tensile force is maintained on a portion of said continuous length of tube being coated and cured.

17. A system for producing metal tube from a continuous sheet of metal comprising;
a forming mill for shaping said continuous sheet of metal into a continuous length of metal tube;
a sizing mill for shaping said continuous metal tube into a predetermined diameter;
a coating system for applying to said continuous length of metal tube a coating capable of being cured by exposure to an electron beam, said coating system having a plurality of electron beam emitters arranged to provide complete curing of said electron beam curable coating; and
a pull-out mill for providing a tensile force on said continuous length of tube through said coating system.

18. A system for producing metal tube from a continuous sheet of metal comprising;
a forming mill for shaping said continuous sheet of metal into a continuous length of metal tube;
a sizing mill for shaping said continuous length of metal tube into a predetermined size;
a coating system having a wash and rinse stage for cleaning said continuous length of metal tube, a dryer stage for drying said tube, a coating stage for applying to said continuous length of metal tube a coating capable of being cured by exposure to an electron beam, said coating system transfer having a plurality of electron beam emitters arranged to provide complete curing of said electron beam curable coating; and
a pull-out mill for providing a tensile force on said continuous length of tube through said coating system.

19. A system for producing metal tube from a continuous sheet of metal as claimed in claim 18 wherein said coating system further comprises a sealer stage for applying a sealant to said continuous length of tube.

20. A system for producing metal tube from a continuous sheet of metal comprising;
a forming mill for shaping said continuous sheet of metal into a continuous length of metal tube;
a sizing mill for shaping said continuous length of metal tube into a predetermined diameter;
a coating system having a wash and rinse stage for cleaning said continuous length of metal tube, a dryer stage for drying said tube, a coating stage for applying to said continuous length of metal tube a coating capable of being cured by exposure to either an electron beam or ultraviolet light, said coating system further having a plurality of electron beam emitters arranged to provide complete curing of an electron beam curable coating and a plurality of ultra violet lamps arranged to provide complete curing of an ultraviolet light curable coating; and
a pull-out mill for providing a tensile force on said continuous length of tube through said coating system.

21. A system for producing metal tube from a continuous sheet of metal as claimed in claim 20 wherein said coating system further comprises a sealer stage for applying a sealant to said continuous length of tube.

22. A system for producing metal tube from a continuous sheet of metal comprising;
a forming mill for shaping said continuous sheet of metal into a continuous length of metal tube;
a sizing mill for shaping said continuous length of metal tube into a predetermined diameter;
a coating system having a wash and rinse stage for cleaning said continuous length of metal tube, a dryer stage for drying said tube, a coating stage for applying to said continuous length of metal tube a coating capable of being cured by exposure to an electron beam and ultraviolet light, said coating system further having a plurality of electron beam emitters arranged to provide complete curing of an electron beam curable coating and a plurality of ultra violet lamps arranged to provide complete curing of an ultraviolet light curable coating; and
a pull-out mill for providing a tensile force on said continuous length of tube through said coating system.

23. A system for producing metal tube from a continuous sheet of metal as claimed in claim 22 wherein said coating system further comprises a sealer stage for applying a sealant to said continuous length of tube.

24. A process for coating tube comprising the steps of:
applying a compressive force to a portion of said tube;
applying an electron-beam curable coating to the portion of said tube under compression; and
exposing the coated portion of said tube to an electron beam to cure the coating applied thereon.

25. A process for coating tube comprising the steps of:
applying a compressive force to a portion of said tube;
applying an electron-beam curable coating to the portion of said tube under compression; and
exposing the coated portion of said tube to an electron beam and ultraviolet light to cure the coating applied thereon.
